(19) United States
(12) Patent Application Publication
(10) Pub. No.: US 2024/0132033 A1
(43) Pub. Date: Apr. 25, 2024

(54) METHOD FOR OPERATING AN ELECTROMECHANICAL BRAKE BOOSTER AND CONTROL UNIT FOR AN ELECTROMECHANICAL BRAKE BOOSTER

(71) Applicant: Robert Bosch GmbH, Stuttgart (DE)

(72) Inventors: Christian Osterland, Oberstenfeld (DE); Nadja Schoeffer, Wertheim (DE); Dominic Zipprich, Winzerhausen (DE)

(21) Appl. No.: 18/485,792

(22) Filed: Oct. 11, 2023

(30) Foreign Application Priority Data
Oct. 18, 2022 (DE) 10 2022 211 071.4

(51) Int. Cl. B60T 8/32

(52) U.S. Cl. CPC B60T 8/3265; B60T 2220/04; B60T 2270/88

(57) ABSTRACT

A method for operating an electromechanical brake booster of a brake system of a vehicle. A virtual dynamic brake pressure value representing a driver braking request of a driver of the vehicle is determined in a control unit of the brake booster using a pedal travel of a brake pedal of the vehicle acquired at the brake booster, a clearance value of the brake system read in via a data bus of the vehicle from a brake control unit of the brake system, and a stiffness factor of the brake system read in via the data bus from the brake control unit.

### CROSS REFERENCE

The present application claims the benefit under 35 U.S.C. § 119 of German Patent Application No. DE 10 2022 211 071.4 filed on Oct. 19, 2022, which is expressly incorporated herein by reference in its entirety.

### FIELD

The present invention relates to a method for operating an electromechanical brake booster, a control unit for an electromechanical brake booster and a corresponding computer program product.

### BACKGROUND INFORMATION

An electromechanical brake booster of a vehicle is mechanically coupled to a brake pedal of the vehicle and increases a pedal force applied to the brake pedal by a driver of the vehicle depending on the situation in order to produce a required hydraulic brake pressure.

To provide feedback to the driver on the brake pedal, a counterforce to the pedal force is required.

When braking using a hydraulic brake system of the vehicle, stepping on the brake pedal first causes brake pistons in brake calipers of the wheel brakes to move until brake pads of the wheel brakes come into contact with brake discs of the wheel brakes. The brake pedal moves by a pedal travel in which only a small counterforce has to be overcome. The brake pressure does not build until the brake pads are in contact and the counterforce is created by the brake pressure in the closed hydraulic brake system. This moves the brake pedal by a further pedal travel that results from the travel-pressure ratio (or pressure-volume ratio) of the hydraulic brake system.

For normal braking, an electrically driven vehicle substantially uses a drive system of the vehicle to recover electrical energy by recuperation. During purely electric braking there is no build-up pf brake pressure in the brake system. Setting the counterforce on the brake pedal without actually existing brake pressure requires a calculated replacement variable, among other things. The counterforce is provided by the electromechanical brake booster using the replacement variable depending on the situation by increasing or reducing a provided boosting force for the pedal force.

### SUMMARY

The present invention provides a method for operating an electromechanical brake booster, a control unit for an electromechanical brake booster and a corresponding computer program product. Advantageous example embodiments, developments, improvements of the present invention are disclosed herein.

The replacement variable for setting the counterforce on the brake pedal can be referred to as virtual brake pressure, virtual brake pressure value or driver braking request. The virtual brake pressure is traditionally calculated in a control unit of the brake system and made available for the electromechanical brake booster via a data bus of the vehicle. The calculation can in particular be carried out in an ESP control unit of the brake system.

To calculate the virtual brake pressure value, the brake system reads the current pedal travel from the electromechanical brake booster via the data bus and corrects the pedal travel with a current clearance value that is continuously updated in the brake system based on the current driving situation. The corrected pedal travel and a processing rule are used to determine a virtual brake pressure value. The virtual brake pressure value is corrected with a current stiffness factor of the brake system that is continuously updated in the brake system based on the current driving situation. The corrected virtual brake pressure value is then sent to the brake booster via the data bus.

As digitization of the vehicle increases, more and more data is sent via the data bus of the vehicle. Furthermore, much of this data is encrypted to satisfy security requirements. This causes delays in the transmission of data. The delays are reflected in longer signal propagation times.

By transmitting the pedal travel to the brake system and transmitting the virtual brake pressure back to the brake booster, two time-critical values are respectively transmitted via the data bus and are delayed each time by the signal propagation times. As a result of the summed delays, the brake booster is able to change the counterforce when the applied pedal force changes only with a corresponding delay. The driver can sense these delays on the brake pedal.

According to an example embodiment of the present invention, the virtual brake pressure value is calculated directly in the brake booster, or directly in a control unit of the brake booster. For this purpose, the current clearance value and the current stiffness factor are read in via the data bus from the brake system or its control unit. The delays caused by transmitting the pedal travel to the brake system and transmitting the virtual brake pressure value back to the brake booster are eliminated.

The current clearance value and the current stiffness factor are not time-critical. An update rate of the clearance value and the stiffness factor can be an order of magnitude lower than an update rate of the virtual braking force value.

The present invention makes it possible to reduce a latency of the virtual braking force value by eliminating signal propagation times on the data bus. This creates an improved pedal feel for the driver of the vehicle. The pedal feel can be perceived as being more direct.

According to an example embodiment of the present invention, a method for operating an electromechanical brake booster of a brake system of a vehicle is provided, wherein a virtual dynamic brake pressure value representing a driver braking request of a driver of the vehicle is determined in a control unit of the brake booster using a pedal travel of a brake pedal of the vehicle acquired at the brake booster, a clearance value of the brake system read in via a data bus of the vehicle from a brake control unit of the brake system and a stiffness factor of the brake system read in via the data bus from the brake control unit.

Ideas concerning embodiments of the present invention may be regarded as being based, among other things, on the thoughts and findings described below.

An electromechanical brake booster is a vehicle component of a vehicle, in particular an electrically driven vehicle. The electromechanical brake booster is mechanically coupled to a brake pedal of the vehicle. A driver of the vehicle expresses his or her driver braking request, i.e. how the strongly vehicle should be decelerated, via a pedal force applied to the brake pedal. The driver thus increases the pedal force when the vehicle is to be decelerated more strongly and decreases the pedal force when less deceleration is intended. The brake booster increases the pedal force with a variable, situation-dependent boost factor. The brake pedal acts on an input rod of the brake booster. The input rod is moved by a pedal travel when the brake pedal is actuated. The pedal travel is measured in the brake booster. In the brake booster, the pedal force applied to the brake pedal is increased by the boost factor. The brake booster acts on a master brake cylinder of a brake system of the vehicle via an output rod.

When the brake pedal is actuated and hydraulic braking is taking place, brake fluid is moved out of the master brake cylinder to wheel brakes of the brake system. If the wheel brakes are disc brakes, the brake fluid pushes brake pistons out of brake calipers of the disc brakes until brake pads of the disc brakes are in contact with brake discs of the disc brakes. If the wheel brakes are drum brakes, the brake pads are pressed against the inside of the drum. To what extent the brake pads have to be moved before they come into contact depends on a clearance of the brake pads. The clearance depends on the tilt of the brake disc in the brake caliper when cornering (dynamic clearance), for example, or also on the restoring behavior of the pistons after the pedal is released (static clearance). The pedal travel until the brake pads come into contact is substantially proportional to the clearance. When the brake pads are in contact, the brake fluid can substantially no longer be moved in the brake system and a brake pressure in the brake system increases, as a result of which the brake pads are pressed on with an increasing force and create friction. How much the brake pressure increases after the brake pads come into contact depends on a stiffness of the brake system. The stiffness depends on a temperature of the brake calipers, for instance, and/or a flexibility of brake lines. The stiffness represents a relationship between the displaced volume (correlates with the pedal travel) and the brake pressure.

When the brake pedal is actuated and electric braking is taking place, brake fluid is similarly moved out of the master brake cylinder into the brake system. The brake fluid is not directed to the wheel brakes there, however, but is instead temporarily stored in a low-pressure reservoir of the brake system so that no brake pressure can build up. The pedal force required to achieve this can be set via the boost factor. The required force can alternatively or additionally be set via valves of the brake system.

The pedal feel (relationships between travel, pedal force and deceleration) when electrical braking is taking place should substantially correspond to the pedal feel when hydraulic braking is taking place. To ensure this, according to an example embodiment of the present invention, it is advantageous if in particular the driver braking request (virtual brake pressure), which depends on the pedal travel, is determined as precisely as possible. In the case of purely hydraulic braking, the driver braking request (virtual brake pressure) should therefore correspond as closely as possible to the real pressure in the brake system. Therefore, the expected clearance in the brake system is continuously updated and adapted to the current driving situation. The expected clearance is reflected in a clearance value. The currently expected stiffness in the brake system is similarly continuously updated and adapted to the current driving situation. The expected stiffness is reflected in a stiffness factor. The clearance value and the stiffness factor can be continuously updated by means of learning algorithms.

A data bus of the vehicle can be a CAN bus or a FlexRay bus, for instance. The data bus can have latencies. The latencies can result from a high capacity utilization of the data bus. The latencies can be between 20 milliseconds and 50 milliseconds per transmission, for example.

In the approach presented here, according to an example embodiment of the present invention, the updated clearance value and the updated stiffness factor are provided by the brake system on the data bus of the vehicle and read in by the brake booster. The pedal travel is acquired in the brake booster. A value representing the pedal travel is preferably ascertained directly in the brake booster, i.e. it does not have to be transmitted via the data bus. The unavoidable latencies of the data bus are less critical for the clearance value and the stiffness factor, because the clearance value and the stiffness factor are updated at a much lower frequency than the latency of the data bus.

At least for electrical braking, a replacement value for the brake pressure is determined using the value representing the pedal travel, the clearance value and the stiffness factor. The replacement value is referred to here as a virtual dynamic brake pressure value. The boost factor is set as a function of the virtual brake pressure value.

Directly ascertaining or using the pedal travel in the brake booster without data bus latency makes it possible to quickly determine the virtual dynamic brake pressure value. The virtual dynamic brake pressure value can thus be determined up to 70 milliseconds faster, for instance, than if the pedal travel is transmitted to the brake system, the virtual brake pressure value is determined in the brake system and the virtual brake pressure value is transmitted back to the brake booster. The additional calculation processes in the functional software can also lead to latency times of up to 105 milliseconds.

Using the value representing the pedal travel furthermore makes it possible to determine a virtual static brake pressure value. The static brake pressure value can be used as a replacement value for the dynamic brake pressure value when the dynamic brake pressure value cannot be determined. The virtual dynamic brake pressure value cannot be determined if the clearance value and/or the stiffness factor cannot be read in via the data bus of the vehicle, for example. The virtual static brake pressure value can be calculated in parallel as a fallback level and provides redundancy with reduced precision of the calculation in the event of an error.

According to an example embodiment of the present invention, the static brake pressure value can be determined in the control unit of the brake booster. The determination directly in the brake booster makes it possible to avoid the latencies of the data bus for the static brake pressure value as well.

According to an example embodiment of the present invention, a further virtual dynamic brake pressure value can be determined in the brake control unit using the pedal travel read in via the data bus from the brake booster, the clearance value and the stiffness factor. The further dynamic brake pressure value can be provided to the control unit via the data bus and used as a replacement value for the dynamic brake pressure value when the dynamic brake pressure value cannot be determined. The virtual dynamic brake pressure value cannot be determined if the clearance value and/or the stiffness factor cannot be read in via the data bus of the vehicle, for example. The further virtual dynamic brake pressure value can be calculated in parallel as a fallback level and provides redundancy with the latency of the data bus in the event of an error, but has the same precision as the calculation in the brake booster.

According to an example embodiment of the present invention, the further dynamic brake pressure value can be used as a replacement value for the dynamic brake pressure value when the dynamic brake pressure value cannot be determined. The static brake pressure value can be used as a replacement value for the further dynamic brake pressure value when the further dynamic brake pressure value cannot be determined. Two fallback levels makes it possible to achieve a high level of safety for electrical braking.

The dynamic brake pressure value can be determined using a pedal travel/pressure characteristic. A pedal travel/pressure characteristic can show a relationship between the pedal travel and the brake pressure. A characteristic curve can easily be read out and requires little computational effort. The characteristic curve can also be stored in the form of a lookup table.

According to an example embodiment of the present invention, the acquired pedal travel can be corrected using the clearance value to obtain a clearance-corrected pedal travel. The clearance-corrected pedal travel can be used as an input variable for the pedal travel/pressure characteristic. The brake pressure value read from the pedal travel/pressure characteristic can be corrected using the stiffness factor to obtain the dynamic brake pressure value. The dynamic brake pressure value can be determined easily and quickly using a sequence of several simple operations. Determining the dynamic brake pressure value requires only little computing power.

The method of the present invention is preferably automated or in particular computer-implemented and can be implemented in software or hardware, for instance, or in a mixed form of software and hardware, for example in a driver assistance system.

The present invention also provides a control unit for an electromechanical brake booster, wherein the control unit is configured to carry out, control or implement the steps of a variant of the method presented here in corresponding devices.

The control unit can be an electrical device comprising at least one computing unit for processing signals or data, at least one memory unit for storing signals or data and at least one interface and/or communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EEPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

A computer program product or a computer program comprising program code that can be stored on a machine-readable carrier or storage medium, such as a semiconductor memory, a hard disk memory or an optical memory, and can be used to carry out, implement and/or control the steps of the method according to any one of the above-described embodiments of the present invention is advantageous as well, in particular when the program product or program is executed on a computer or a device.

It should be noted that some of the possible features and advantages of the present invention are described here with reference to different embodiments. A person skilled in the art will recognize that the features of the control unit and the method can be suitably combined, adapted, or interchanged to arrive at further embodiments of the present invention.

### BRIEF DESCRIPTION OF THE DRAWING

Embodiments of the present invention are described in the following with reference to the FIGURE, wherein neither the FIGURE nor the description are to be construed as limiting the present invention.

FIG. 1 shows an illustration of an electromechanical brake booster of a vehicle comprising a control unit according to an embodiment example of the present invention.

This FIGURE is merely schematic and not to scale. Identical reference signs denote identical or functionally identical features.

### DETAILED DESCRIPTION OF EXAMPLE EMBODIMENTS

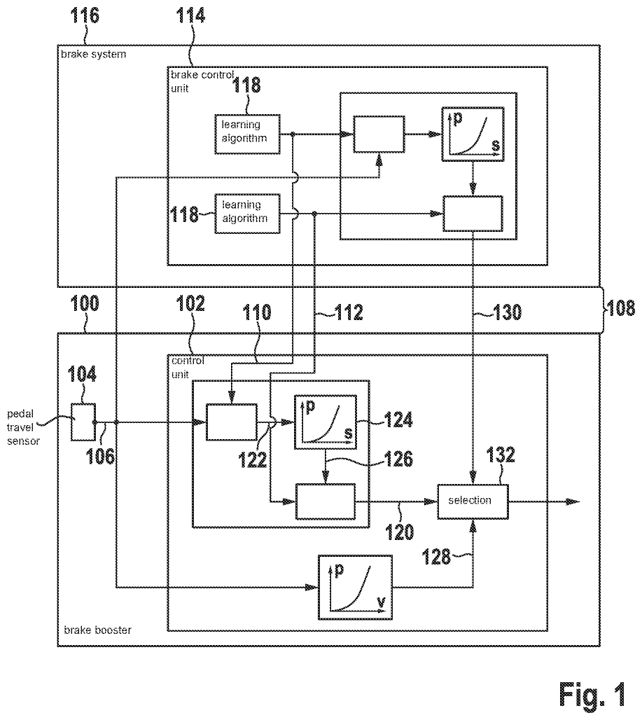

FIG. 1 shows an illustration of an electromechanical brake booster 100 of a vehicle comprising a control unit 102 according to an embodiment example. The brake booster 100 can be referred to as the iBooster. The electromechanical brake booster 100 is mechanically coupled to a brake pedal of the vehicle. The brake booster 100 comprises a pedal travel sensor 104 for acquiring a pedal travel 106 of the brake pedal. The pedal travel 106 is read in by the control unit 102.

The control unit 100 is connected to a data bus 108 of the vehicle. The control unit 100 reads in a current clearance value 110 and a stiffness factor 112 from a brake control unit 114 of a brake system 116 of the vehicle via the data bus 108. The brake control unit 114 here is an ESP control unit of the vehicle.

The current clearance value 110 and the stiffness factor 112 are continuously updated in the brake control unit 114 and adapted to a current driving situation. For this purpose, learning algorithms 118 for the clearance value 110 and the stiffness factor 112 are executed in the brake control unit 114 and the clearance value 110 and the stiffness factor 112 are provided via the data bus 108.

A virtual dynamic brake pressure value 120 is determined in the control unit 102 using the pedal travel 106, the clearance value 110 and the stiffness factor 112. The virtual dynamic brake pressure value 120 represents a driver braking request of a driver of the vehicle actuated on the brake pedal.

The virtual dynamic brake pressure value 120 is used in the brake booster 100 to set a counterforce on the brake pedal via a variable boost factor of the brake booster 100.

To determine the virtual dynamic brake pressure value 120, the pedal travel 106 is first corrected using the clearance value 110 in order to obtain a clearance-corrected pedal travel 122. The clearance-corrected pedal travel 122 is then used as an input variable for a processing rule with a pedal travel/pressure characteristic 124 to read a brake pressure value 126 from the pedal travel/pressure characteristic 124. The brake pressure value 126 is then corrected using the stiffness factor 112 to obtain the virtual dynamic brake pressure value 120.

In one embodiment example, a virtual static brake pressure value 128 is determined from the pedal travel 106 in parallel with the determination of the virtual dynamic brake pressure value 120. The determination of the virtual static brake pressure value 128 does not use any variables read in via the data bus 108. The virtual static brake pressure value 128 can therefore also be determined if the data bus 108 is faulty, and no information can be read in from the data bus 108, for instance.

In one embodiment example, the pedal travel 106 is provided to the brake control unit 114 via the data bus 108. A further virtual dynamic brake pressure value 130 is determined in the brake control unit 114 using the braking distance 106, the clearance value 110 and the stiffness factor 112 and is made available via the data bus 108. Due to network delay times of the data bus 108 during transmission, the further virtual dynamic brake pressure value 130 can only be read in by the control unit 102 of the brake booster 100 with a latency in the range of 100 milliseconds. The further virtual dynamic brake pressure value 130 corresponds very precisely to the virtual dynamic brake pressure value 120, but has a time delay.

In one embodiment example, a selection 132 of the available brake pressure values 120, 128, 130 is carried out in the control unit 102 of the brake booster 100. If the virtual dynamic brake pressure value 120 determined in the control unit 102 can be determined, the virtual dynamic brake pressure value 120 determined in the control unit 102 is made available to the brake booster.

If the virtual dynamic brake pressure value 120 determined in the control unit 102 cannot be determined, but the further virtual dynamic brake pressure value 130 determined in the brake control unit 114 can be determined, the further virtual dynamic brake pressure value 130 determined in the brake control unit 114 is made available to the brake booster 100.

If neither the virtual dynamic brake pressure value 120 determined in the control unit 102 nor the further virtual dynamic brake pressure value 130 determined in the brake control unit 114 can be determined, the virtual static brake pressure value 128 determined in the control unit 102 is made available to the brake booster 100.

Possible embodiments of the invention are summarized again below or presented with a slightly different choice of words.

An elimination of latency times for driver braking request recognition is presented.

Brake boosters such as the vacuum brake booster have long been found in vehicles. The development of electromechanical brake boosters takes the electrification of vehicles into account. An electromechanical brake booster (iBooster) can support the driver's braking command depending on the situation.

The electromechanical brake booster (iBooster) can be addressed via a uniform interface as an interface to the ESP.

The driver braking request (pMCvirtual) is traditionally determined by calculating a virtual pressure in the Driver Brake Request (DBR) function in the ESP. One key piece of information for this is the pedal travel provided by the iBooster (sOutputRodDriver, sOutputRodAct). To make the model-based driver braking request ascertainment in the ESP as accurate as possible, influences on the brake hardware, for example stiffness, wear, temperature influences and clearance behavior, are taken into account.

Due to network delay times, all signals sent via a vehicle bus, such as CAN, CAN-FD or FlexRay, are subject to a certain amount of latency. Since more and more security measures are currently being taken into account in vehicle communication, these delay times are constantly increasing. One reason for this is the encryption and decryption of signals, for instance.

The longer the delay times for the pMCvirtual, the greater the delay of the engagement of the pedal feel adjustment mechanisms in the iBooster that use this signal as the relevant input variable. The software-based pedal feel adjustment (PFA—pedal force amplification) and the pedal force blending (PFC—pedal force compensation) required for recuperative braking, for example, are determined on the basis of delayed signals. This goes against a directly perceptible force feedback for the driver, who initiates a change in the driver braking request with his movement of the pedal.

Therefore, an elimination of the network delay times for determining the driver braking request in the electromechanical brake booster with security measures and FlexRay is presented here. This reduces the delay for the transmission of the pedal travel from the brake booster to the ESP by ˜35 ms and the delay for the transmission of the driver braking request from the ESP to the brake booster by another ˜35 ms. Overall, this results in a total delay reduction of ˜70 ms. The network delay is avoided because pMCvirtual is calculated directly in the iBooster.

The approach presented here provides increased comfort, since it enables more direct feedback and a more natural pedal feel. Eliminating the network delay times results in a relationship between pedal force, pedal travel and vehicle deceleration that is similar to purely hydraulic braking.

To eliminate the network delay times, a communication matrix of the brake booster and the ESP is extended and functional components from the ESP are transferred to the iBooster, which enables a parallel calculation of the driver braking request. For this purpose, the interfaces for “clearance” and “stiffness” are redefined. There is no functional change in the ESP. Only the newly defined signals are output. The influences on the “clearance” and the “stiffness” continue to be calculated in the ESP. The signals provided for the “clearance” and the “stiffness” are subject to a change that is less critical in terms of time, as a result of which the network delay time can be neglected.

Lastly, it should be noted that terms such as “comprising”, “including”, etc. do not exclude other elements or steps and terms such as “one” or “a” do not exclude a plurality. Reference signs in the claims should not be construed as limitations.

What is claimed is:

1. A method for operating an electromechanical brake booster of a brake system of a vehicle, the method comprising:
determining, in a control unit of the brake booster, a virtual dynamic brake pressure value representing a driver braking request of a driver of the vehicle, using a pedal travel of a brake pedal of the vehicle acquired at the brake booster, a clearance value of the brake system read in via a data bus of the vehicle from a brake control unit of the brake system, and a stiffness factor of the brake system read in via the data bus from the brake control unit.

2. The method according to claim 1, further comprising:
determining a further virtual dynamic brake pressure value, in the brake control unit, using the pedal travel read in via the data bus from the brake booster, the clearance value, and the stiffness factor, wherein the further dynamic brake pressure value is provided to the control unit via the data bus and used as a replacement value for the dynamic brake pressure value when the virtual dynamic brake pressure value cannot be determined.

3. The method according to claim 1, further comprising:
determining a virtual static brake pressure value using the pedal travel, wherein the virtual static brake pressure value is used as a replacement value for the virtual dynamic brake pressure value when the virtual dynamic brake pressure value cannot be determined.

4. The method according to claim 3, wherein the virtual static brake pressure value is determined in the control unit of the brake booster.

5. The method according to claim 2, further comprising:
determining a virtual static brake pressure value using the pedal travel, wherein the virtual static brake pressure value is used as a replacement value for the virtual dynamic brake pressure value when the virtual dynamic brake pressure value cannot be determined;
wherein the further dynamic brake pressure value is used as a replacement value for the virtual dynamic brake pressure value when the virtual dynamic brake pressure value cannot be determined, and the virtual static brake pressure value is used as a replacement value for the further dynamic brake pressure value when the further dynamic brake pressure value cannot be determined.

6. The method according to claim 1, wherein the virtual dynamic brake pressure value is determined using a pedal travel/pressure characteristic.

7. The method according to claim 6, wherein the acquired pedal travel is corrected using the clearance value to obtain a clearance-corrected pedal travel, the clearance-corrected pedal travel being used as an input variable for the pedal travel/pressure characteristic, and a brake pressure value read from the pedal travel/pressure characteristic is corrected using the stiffness factor to obtain the virtual dynamic brake pressure value.

8. A control unit for an electromechanical brake booster, the control unit of the electromechanical brake booster being configured to:
determine, in the control unit of the brake booster, a virtual dynamic brake pressure value representing a driver braking request of a driver of the vehicle, using a pedal travel of a brake pedal of the vehicle acquired at the brake booster, a clearance value of the brake system read in via a data bus of the vehicle from a brake control unit of the brake system, and a stiffness factor of the brake system read in via the data bus from the brake control unit.

9. A non-transitory machine-readable storage medium on which is stored a computer program for operating an electromechanical brake booster of a brake system of a vehicle, the computer program, when executed by a processor, causing the processor to perform:
determining, in a control unit of the brake booster, a virtual dynamic brake pressure value representing a driver braking request of a driver of the vehicle, using a pedal travel of a brake pedal of the vehicle acquired at the brake booster, a clearance value of the brake system read in via a data bus of the vehicle from a brake control unit of the brake system, and a stiffness factor of the brake system read in via the data bus from the brake control unit.
